(19) United States
(12) Patent Application Publication
(10) Pub. No.: US 2025/0074424 A1
(43) Pub. Date: Mar. 6, 2025

(54) VEHICLE PASSING OPERATION

(71) Applicant: Ford Global Technologies, LLC, Dearborn, MI (US)

(72) Inventors: Daniel Sullivan, West Bloomfield, MI (US); Tyler James-Ray Kaldobsky, Canton, MI (US)

(73) Assignee: Ford Global Technologies, LLC, Dearborn, MI (US)

(21) Appl. No.: 18/460,085

(22) Filed: Sep. 1, 2023

(51) Int. Cl. B60W 30/18; B60W 10/20; B60W 30/14; B60W 40/04; B60W 40/06; H04W 4/40

(52) U.S. Cl. CPC B60W 30/18163; B60W 10/20; B60W 30/143; B60W 40/04; B60W 40/06; H04W 4/40; B60W 2554/406; B60W 2555/20; B60W 2556/50; B60W 2556/65

(57) ABSTRACT

Systems and methods for pass zone vehicle control include receiving, via wireless communications, respective vehicle data for each of a plurality of vehicles on a roadway, the vehicle data including at least speed and location data. A set of current pass zones and a set of current no-pass zones on the roadway is determined based on the speed and location data from the plurality of vehicles, a set of static no-pass zones, and a set of static pass zones. A control parameter is then transmitted for a candidate passing vehicle in the plurality of vehicles, wherein the control parameter is determined based on the set of current pass-zones and the set of current no-pass zones.

### BACKGROUND

A two-lane roadway may have centerline markings to indicate a passing zone where passing is permitted (a dashed line) and a no passing zone where passing is not permitted (a solid line) in either of the lanes. When passing is not permitted, a “NO PASSING ZONE” sign may also be posted. A vehicle may want to pass a slower moving vehicle travelling in the same lane and may do this in a passing zone when conditions allow.

### BRIEF DESCRIPTION OF THE DRAWINGS

FIG. 1 is diagram of an example system for providing vehicle passing operation.

FIG. 2A is an example diagram of a two-lane roadway illustrating static pass zones and static no-pass zones.

FIGS. 2B and 2C are example diagrams of a two-lane roadway illustrating current pass zones and current no-pass zones.

FIG. 2D is an example diagram of a two-lane roadway for evaluation of a vehicle passing operation.

FIGS. 3A and 3B are further example diagrams of a two-lane roadway illustrating pass zones and no-pass zones.

FIG. 4 is a process flow diagram of an example process for a vehicle passing operation.

FIG. 5 is a process flow diagram of a further example process for a vehicle passing operation.

FIG. 6 is a process flow diagram of a further example process for a vehicle passing operation.

### DETAILED DESCRIPTION

Data about vehicles along a portion of a roadway, such as a vehicle's location, speed, length, width, and/or planned or predicted route or path, may be provided to a remote or central computer programmed to predict areas where a first vehicle may pass one or more second vehicles on the roadway. The central computer may also obtain data about the roadway, such as centerline markings, curves, road width, hills, construction, and weather conditions from vehicles and/or from one or more databases. The central computer can determine a set of current pass zones and no-pass zones for a first vehicle to pass a second vehicle on the roadway based on the vehicle data and the roadway data. Control parameters such as a speed adjustment may be sent to one or more vehicles so that a first vehicle can pass a second vehicle in a current pass zone.

In one or more implementations, a system may have a computer including a processor and a memory, the memory storing instructions executable by the processor such that the computer is programmed to: receive, via wireless communications, respective vehicle data for each of a plurality of vehicles on a roadway, the vehicle data including at least speed and location data; determine a set of current pass zones and a set of current no-pass zones on the roadway based on the speed and location data from the plurality of vehicles, a set of static no-pass zones, and a set of static pass zones; and transmit a control parameter for a candidate passing vehicle in the plurality of vehicles, wherein the control parameter is determined based on the set of current pass-zones and the set of current no-pass zones.

An implementation of the system may further include instructions to transmit one or more further respective control parameters to one or more vehicles in the plurality of vehicles, in addition to transmitting the control parameter to the candidate passing vehicle.

In another implementation of the system, the control parameter may include a steering instruction for the candidate passing vehicle.

A further implementation of the system may include instructions to determine the control parameter based on a location of a current pass zone selected from the set of current pass zones.

In another implementation of the system, the instructions to determine the sets of current pass-zones and current no-pass zones may take a location of the candidate passing vehicle into consideration.

In a further implementation of the system, the location of the candidate passing vehicle may be used to define a start point for a look-ahead distance for a portion of the roadway evaluated to determine the sets of current pass zones and current no-pass zones, wherein the look-ahead distance may be selected from a fixed distance, an adjustable distance based upon traffic conditions, an adjustable distance based upon weather conditions, or an adjustable distance based upon the candidate passing vehicle.

In an implementation of the system, the instructions to determine the sets of current pass-zones and current no-pass zones may take a roadway condition into consideration.

In another implementation of the system, the roadway condition may include one of a width, a curve, a grade, a surface condition, and a weather condition.

In an implementation of the system, the vehicle data may include vehicle dimension data.

In another implementation of the system, at least one of the sets of current pass-zones, current no-pass zones, static no-pass zones, and static pass zones may be empty.

A further implementation of the system may include instructions to receive, from the candidate passing vehicle, a pass zone request.

Another implementation of the system may include instructions to receive the vehicle data for a first one of the plurality of vehicles from a roadside infrastructure element or a second one of the plurality of vehicles.

A further implementation of the system may include a vehicle computer in the candidate passing vehicle including a processor and a memory, the memory storing instructions executable by the processor such that the vehicle computer is programmed to control at least one of speed or steering according to the transmitted control parameter.

One or more implementations of a method may include: receiving, via wireless communications, respective vehicle data for each of a plurality of vehicles on a roadway, the vehicle data including at least speed, location, and dimension data; determining a set of current pass zones and a set of current no-pass zones on the roadway based on the speed and location data from the plurality of vehicles, a set of static no-pass zones, and a set of static pass zones; and transmitting a control parameter for a candidate passing vehicle in the plurality of vehicles, wherein the control parameter is determined based on a location of a current pass zone selected from the set of current pass zones.

An implementation of the method may further include transmitting one or more further respective control parameters to one or more participating vehicles in the plurality of vehicles, in addition to transmitting the control parameter to the candidate passing vehicle.

In another implementation of the method, determining the sets of current pass-zones and current no-pass zones may further be based on a location of the candidate passing vehicle and a roadway condition that includes one of a curve, a grade, a lane width, a surface condition, or a weather condition.

In a further implementation of the method, the location of the candidate passing vehicle may be used to define a start point for a look-ahead distance for a portion of the roadway evaluated to determine the sets of current pass zones and current no-pass zones, wherein the look-ahead distance may be selected from a fixed distance, an adjustable distance based upon traffic conditions, an adjustable distance based upon weather conditions, or an adjustable distance based upon the candidate passing vehicle.

An implementation of the method may further include, in the candidate passing vehicle, controlling at least one of speed or steering according to the control parameter.

Another implementation of the method may include receiving the vehicle data for a first one of the plurality of vehicles from a roadside infrastructure element or a second one of the plurality of vehicles.

An implementation of the method may further include receiving, from the candidate passing vehicle, a pass zone request.

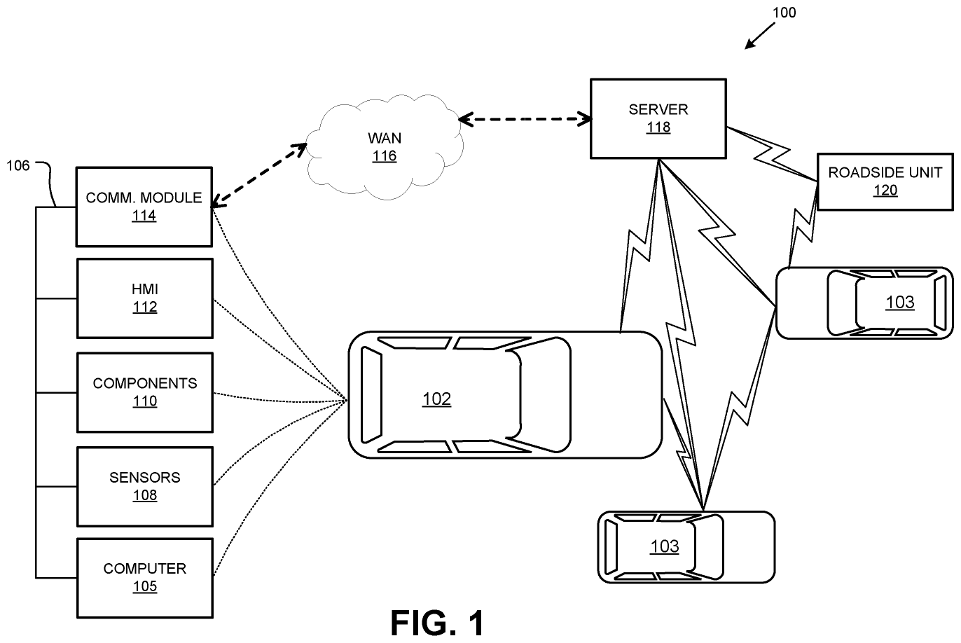

With reference to FIG. 1, a connected vehicle system 100 can provide communications between a vehicle 102, other vehicles 103, a server 118, and one or more roadside units 120.

Vehicle 102 is a set of components or parts, including hardware components and typically also software and/or programming, to perform a function or set of operations in vehicle 102. Other vehicles 103 may be similar to vehicle 102. Vehicle components 110 typically include a braking system, a propulsion system, and a steering system as well as other subsystems including but not limited to an advanced driver assist system (ADAS) including various driver assist technology (DAT) such as a Global Navigation Satellite System (GNSS) based routing system, a body control system, a climate control system, and a lighting system. The propulsion subsystem converts energy to rotation of vehicle 102 wheels to propel the vehicle 102 forward and/or backward. The braking subsystem can slow and/or stop vehicle 102 movement. The steering subsystem can control turning left and right, and/or maintaining a straight path, of the vehicle 102 as it moves.

Vehicle 102 may also include a human-machine interface (HMI) 112, which may include a microphone, a heads-up display (HUD), an instrument panel, an interface to control one or more components 110, and infotainment system. HMI 112 may include one or more display screens, and one or more of the display screens may receive input via touchscreen control, voice control, and/or physical knobs and switches. For example, map data, route information, and routing instructions for the GNSS-based routing system may be displayed on HMI 112 and receive input by voice or touch.

Computers, including the herein-discussed one or more vehicle computers 105 (e.g., one or more electronic control units (ECUs)), server 118, and roadside units 120 include respective processors and memories. A computer memory can include one or more forms of computer readable media, and stores instructions executable by a processor for performing various operations, including as disclosed herein. For example, the computer can be a generic computer with a processor and memory as described above and/or an ECU, controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., EEPROM, EPROM, ROM, Flash, hard disk drives, solid state drives, servers, or any volatile or non-volatile media. The memory can store data, e.g., a memory of an ECU. The memory can be a separate device from the computer, and the computer can retrieve information stored in the memory, e.g., one or more computers 105 can obtain data to be stored via a vehicle network 106 in the vehicle 102, e.g., over an Ethernet bus, a CAN bus, a wireless network, etc. Alternatively, or additionally, the memory can be part of computer 105, i.e., as a memory of the computer 105 or firmware of a programmable chip.

The one or more vehicle computers 105 (e.g., one or more ECUs) can be included in a vehicle 102 that may be any suitable type of ground vehicle 102, e.g., a passenger or commercial automobile such as a sedan, a coupe, a truck, a sport utility, a crossover, a van, a minivan, etc. As part of a driver assist system or an advanced driver assist system (ADAS), a vehicle computer 105 may include programming to operate one or more of vehicle 102 brakes, propulsion (e.g., control of acceleration in the vehicle 102 by controlling one or more of an internal combustion engine (ICE), electric motor, hybrid ICE/electric propulsion, etc. and control power delivery therefrom), steering, climate control, interior and/or exterior lights, etc., as well as to determine whether and when the computer, as opposed to a human operator, is to control such operations, such as by sending vehicle data over the vehicle network 106. Additionally, a vehicle computer 105 may be programmed to determine whether and when a human operator is to control such operations.

Vehicle computer 105 may include or be communicatively coupled to, e.g., via a vehicle network 106 such as a communications bus as described further below, more than one processor, e.g., included in sensors 108, electronic controller units (ECUs) or the like included in the vehicle 102 for monitoring and/or controlling various vehicle components, e.g., a powertrain controller, a brake controller, a steering controller, etc. The computer is generally arranged for communications on a vehicle 102 communication network that can include a bus in the vehicle 102 such as a controller area network (CAN) or the like, and/or other wired and/or wireless mechanisms. Alternatively, or additionally, in cases where the computer actually includes a plurality of devices, the vehicle network 106 may be used for communications between devices represented as the computer in this disclosure.

Vehicle network 106 is a network via which messages can be exchanged between various devices in vehicle 102. The vehicle computer 105 can be generally programmed to send and/or receive, via vehicle network 106, messages to and/or from other devices in vehicle 102 e.g., any or all of ECUs, sensors 108, actuators, components 110, communications module 114, HMI 112, etc. Additionally, or alternatively, messages can be exchanged among various such other devices in vehicle 102 via a vehicle network 106. In cases in which the vehicle computer 105 includes a plurality of devices, vehicle network 106 may be used for communications between devices represented as a computer in this disclosure. In some implementations, vehicle network 106 can be a network in which messages are conveyed via a vehicle 102 communications bus. For example, vehicle network 106 can include a controller area network (CAN) in which messages are conveyed via a CAN bus, or a local interconnect network (LIN) in which messages are conveyed via a LIN bus. In some implementations, vehicle network 106 can include a network in which messages are conveyed using other wired communication technologies and/or wireless communication technologies e.g., Ethernet, Wi-Fi, Bluetooth, Ultra-Wide Band (UWB), etc. Additional examples of protocols that may be used for communications over vehicle network 106 in some implementations include, without limitation, Media Oriented System Transport (MOST), Time-Triggered Protocol TTP, and FlexRay. In some implementations, vehicle network 106 can represent a combination of multiple networks, possibly of different types, that support communications among devices in vehicle 102. For example, vehicle network 106 can include a CAN in which some devices in vehicle 102 communicate via a CAN bus, and a wired or wireless local area network in which some device in vehicle 102 communicate according to Ethernet or WI-FI communication protocols.

Vehicle computer 105, server 118, and/or roadside unit 120 can communicate via a wide area network 116. Further, various computing devices discussed herein may communicate with each other directly, e.g., via direct radio frequency communications according to protocols such as Bluetooth or the like. For example, vehicle 102 (as well as other vehicles 103) can include a communication module 114 to provide communications with devices and/or networks not included as part of the vehicle 102, such as a Global Navigation Satellite System (GNSS, not shown) and the wide area network 116, for example. Communication module 114 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle 103 or infrastructure such as roadside unit 120 typically via direct radio frequency communications and/or typically via the wide area network 116, e.g., to the server 118. The communication module 114 could include one or more mechanisms by which a vehicle computer 105 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, cellular V2X, CV2X, and the like.

A vehicle 102 in accordance with the present disclosure includes a plurality of sensors 108 that may support the driver assist or ADAS functions. For example, sensors 108 may include, but are not limited to, a LiDAR sensor, one or more wheel speed sensor, steering angle sensor, GNSS sensor, forward-facing camera, side-facing camera, rear-facing camera, ultrasonic parking assist sensor, short range RADAR, medium range RADAR, light sensor, rain sensor, accelerometer, wheel torque sensors, inertial sensor, turning sensor, etc.

A roadside unit 120, sometimes referred to as an edge unit, infrastructure node, roadside infrastructure unit, or RSU, includes a physical structure such as a tower or other support structure (e.g., a pole, a box mountable to a bridge support, cell phone tower, road sign support, etc.) on or in which sensors, a communications module, and computer can be housed, mounted, stored, and/or contained, and powered, etc. A roadside unit 120 is typically stationary, i.e., fixed to and not able to move from a specific physical location. The computer of roadside unit 120 includes a processor and a memory such as described above with respect to vehicle computer 105. The roadside unit 120 also includes a power source such as a battery, solar power cells, and/or a connection to a power grid. One roadside unit 120 is shown in FIG. 1 for ease of illustration, but the system 100 could include a plurality of roadside units 120 along a roadway.

The roadside unit 120 may include one or more sensors having a field of view such as described above for the vehicle 102 sensors 108, e.g., LiDAR, radar, cameras, ultrasonic sensors, etc. The sensors are typically fixed or stationary. That is, each sensor can be mounted to the infrastructure element so as to have a substantially unmoving and unchanging field of view. Alternatively or additionally, a sensor included in a roadside unit 120 could be movable to adjust the sensor's field of view. In the present context, for a sensor to be included in a roadside unit 120 means that the sensor is deployed on, in, or near the roadside unit 120 and provides data to a computer in the roadside unit 120 that can communicate via the communications module with other devices such as the server 118 and/or vehicles 102, 103.

The communications module of roadside unit 120 may include one or more mechanisms, e.g., conventional radio frequency transmitter and receiver components, by which the computer of roadside unit 120 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module can include cellular, Bluetooth, IEEE 802.11, dedicated short range communications (DSRC), cellular V2X (CV2X), and the like.

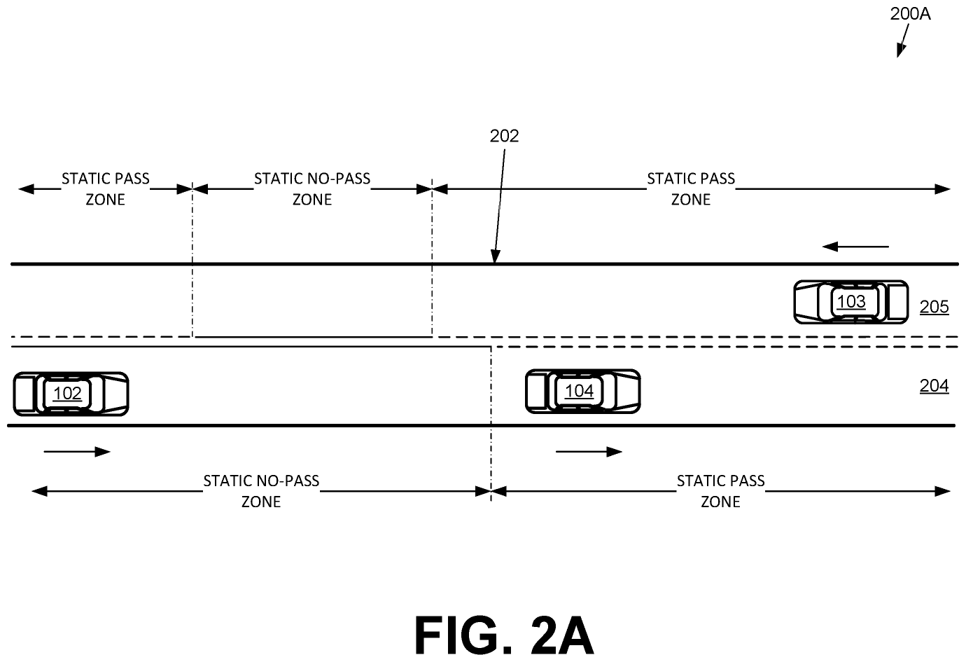

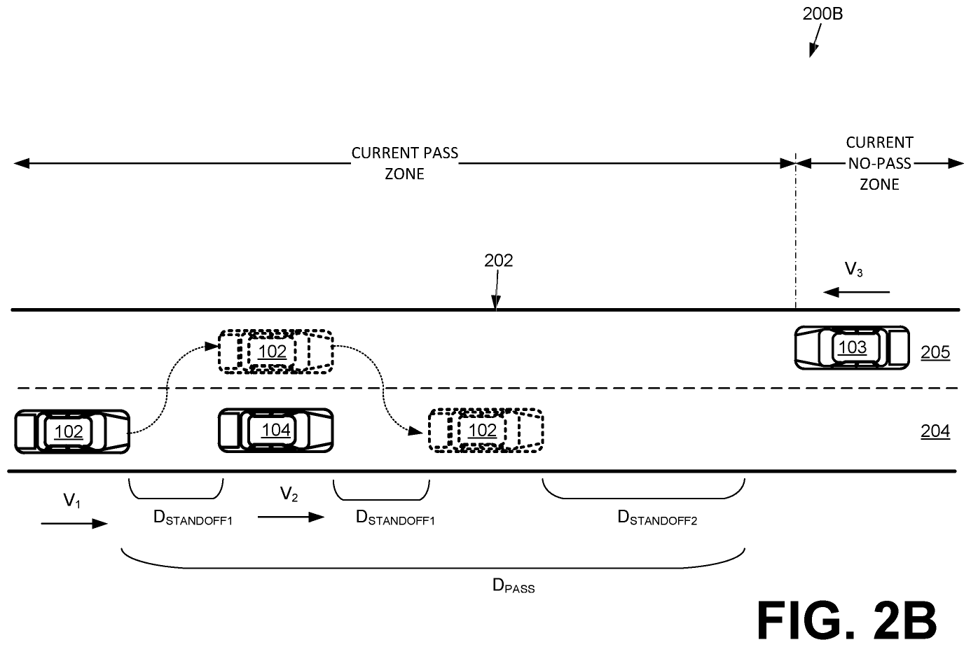

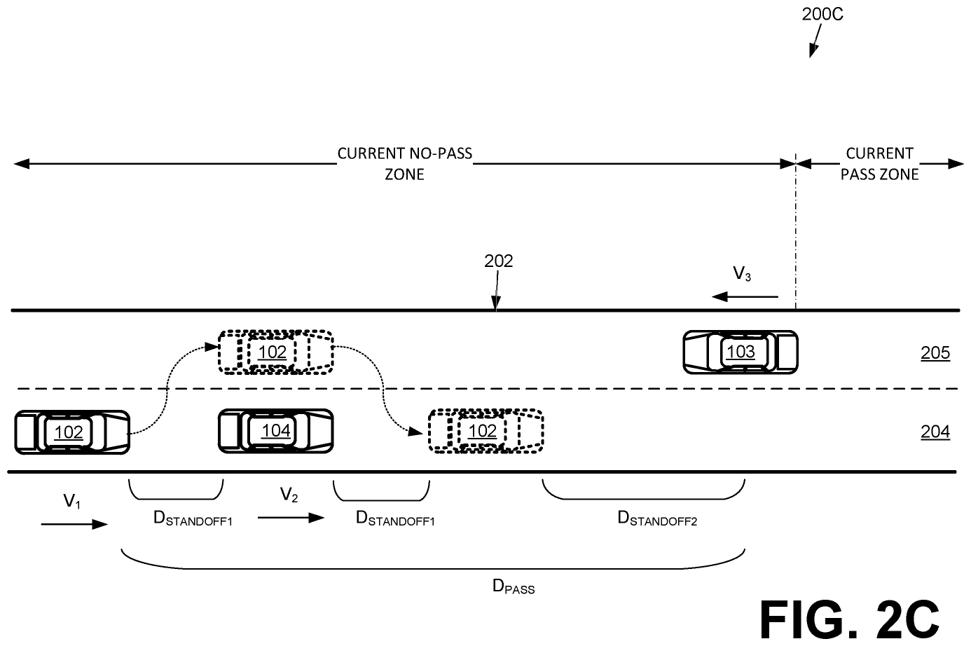

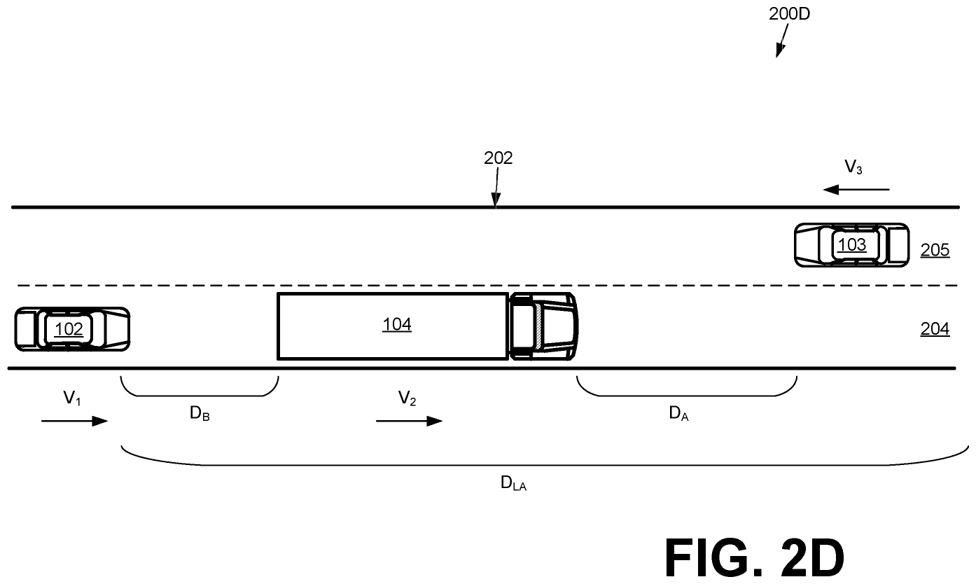

FIG. 2A is a diagram of an example two-lane roadway scenario 200A. FIG. 2A is not to scale.

In scenario 200A, vehicles 102, 103, and 104 are traveling on a roadway 202 that has two lanes 204 and 205, one in each of two opposing directions. Vehicle 102 is travelling in a same direction and lane 204 as vehicle 104. Additionally, vehicle 103 is travelling in the opposite direction in lane 205.

Roadway 202 includes centerline markings indicating zones where passing is permitted (a dashed line) and where passing is not permitted (a solid line) in either of the lanes 204 and 205. These zones are herein referred to as static no-pass zones and static pass zones, respectively. In this example, the centerline markings for lane 204 indicate vehicle 102 is travelling in a static no-pass zone and vehicle 104 is travelling in a static pass zone. Additionally, the centerline markings for lane 205 indicate that vehicle 103 is travelling in a static pass zone and, upon travelling further on lane 205, will encounter a static no-pass zone and static pass zone. These static pass zones and static no-pass zones do not change based on traffic or weather conditions since they only indicate where passing is permitted or not, not necessarily where a vehicle passing operation may be accomplished.

With reference to FIG. 2B, an example schematic diagram of a two-lane roadway scenario 200B for a potential vehicle passing operation is illustrated. FIG. 2B is not to scale and is provided to illustrate the concept of a current pass zone.

In this example, roadway 202 includes centerline markings indicating that passing is permitted in the travel direction of vehicles 102 and 104. Accordingly, the illustrated portion of roadway 202 in this example is a static pass zone.

In scenario 200B, vehicles 102, 103, and 104 are traveling on roadway 202 that has two lanes 204 and 205, one in each of two opposing directions. Vehicle 102 is travelling at a speed V₁ in a same direction and lane 204 as vehicle 104 travelling at a speed V₂, which for purposes of this example is a speed lower than V₁ such that a potential vehicle passing operation may exist. Additionally, vehicle 103 is travelling in the opposite direction in lane 205 at a speed of V₃.

Vehicles travelling in the same direction and lane 204, e.g., vehicle 102 and vehicle 104, may maintain a first standoff distance D_{STANDOFF1} to prevent operating within a distance of each other that is less than D_{STANDOFF1}. Additionally, during a passing operation, vehicle 102 may maintain a second standoff distance D_{STANDOFF2} to prevent operating within a distance of an opposing vehicle 103 less than D_{STANDOFF2} when in lane 205. As used herein, a standoff distance is a predetermined distance from another vehicle in which a vehicle should not encroach. It may be determined empirically or by any other suitable means and may vary based upon speed and road conditions such as weather, traffic density, and the like.

A computer, such as server 118, may estimate a passing distance D_{PASS} that includes a distance of roadway 202 required for vehicle 102 at speed V₁ to pass vehicle 104 at speed V₂ while maintaining standoff distances D_{STANDOFF1} and D_{STANDOFF2}. For example, server 118 may calculate the time/for vehicle 102 to travel the combined distance of D_{STANDOFF1}, a length of vehicle 104, and D_{STANDOFF2} at the relative velocity of V₁-V₂ in order to perform the passing operation shown in dotted lines. The server 118 may then calculate an estimated distance that the vehicle 102 travels along roadway 202 during time t as V₁*t to calculate an estimated passing distance D_{PASS}. Although not illustrated, the passing distance D_{PASS} may also include a buffer distance to account for uncertainties, such as another 10-20% due to possible speed variations due to terrain, wind, etc., which will lengthen the time t of the passing operation.

The server 118 may designate the static pass zone of roadway 202 as a current pass zone when vehicle 103 is predicted to be further down roadway 202 than the estimated passing distance D_{PASS} at the end of time t, as illustrated by the vehicle 103 in scenario 200B, so as to permit a vehicle pass operation. However, as explained further with respect to FIG. 2C, the boundaries of current pass zones are dynamic and server 118 may determine that the static pass zone of roadway 202 may be a current no-pass zone at the point where a predicted position of vehicle 103 comes within the estimated passing distance D_{PASS} in front of vehicle 102. As used herein, a predicted position or position of an opposing vehicle within the passing distance D_{PASS} is referred to as a predicted overlap or overlap.

With reference to FIG. 2C, an example schematic diagram of a two-lane roadway scenario 200C for a potential vehicle passing operation is illustrated. FIG. 2C is not to scale and is provided to illustrate the concept of a current no-pass zone. Note that, although not illustrated in this example, a static no-pass zone will necessarily be a current no pass zone for vehicles travelling in the same direction since passing is not permitted in a static no-pass zone.

In this example, roadway 202 includes centerline markings indicating that passing is permitted in the travel direction of vehicles 102 and 104. Accordingly, the illustrated portion of roadway 202 in this example is a static pass zone.

In scenario 200C, vehicles 102, 103, and 104 are traveling on roadway 202 that has two lanes 204 and 205, one in each of two opposing directions. Vehicle 102 is travelling at a speed V₁ in a same direction and lane 204 as vehicle 104 travelling at a speed V₂, which for purposes of this example is a speed lower than V₁ such that a potential vehicle passing operation may exist. Additionally, vehicle 103 is travelling in the opposite direction in lane 205 at a speed of V₃.

Vehicles travelling in the same direction and lane 204, e.g., vehicle 102 and vehicle 104, may maintain a first standoff distance D_{STANDOFF1} as explained above. Additionally as explained above, during a passing operation, vehicle 102 may maintain a second standoff distance D_{STANDOFF2} with respect to an opposing vehicle 103.

A computer, such as server 118, may estimate a passing distance D_{PASS} that includes a distance of roadway 202 required for vehicle 102 at speed V₁ to pass vehicle 104 at speed V₂ while maintaining standoff distances D_{STANDOFF1} and D_{STANDOFF2}. For example, server 118 may calculate the time/for vehicle 102 to travel the combined distance of D_{STANDOFF1}, a length of vehicle 104, and D_{STANDOFF2} at the relative velocity of V₁-V₂ in order to perform the passing operation shown in dotted lines. The server 118 may then calculate an estimated distance that the vehicle 102 travels along roadway 202 during time t as V₁*t to calculate an estimated passing distance D_{PASS}. Although not illustrated, the passing distance D_{PASS} may also include a buffer distance to account for uncertainties, such as another 10-20% due to possible speed variations due to terrain, wind, etc., which will lengthen the time t of the passing operation.

The server 118 may designate the static pass zone of roadway 202 as a current no-pass zone if vehicle 103 is predicted to be within the portion of roadway 202 that overlaps with the estimated passing distance D_{PASS} at the end of time t, as illustrated by the vehicle 103 in scenario 200C. The server 118 may also designate that the static pass zone of roadway 202 as a current pass zone at the point where vehicle 103 passes vehicle 102 (i.e., behind vehicle 103) if no further vehicles are in lane 205 within the passing distance D_{PASS}.

Accordingly, as illustrated by FIGS. 2A, 2B, and 2C, a server 118 may determine that portions of roadway 202 that are static pass zones may be current pass zones or current no-pass zones based upon traffic conditions. Additionally, standoff distances D_{STANDOFF1} and D_{STANDOFF2} may vary based upon traffic speed and/or road conditions (darkness, rain, snow, fog, glare, construction, etc.), such that the length and position of current pass zones and current no-pass zones may also vary based upon traffic speed and/or road conditions.

FIG. 2D illustrates an example two-lane roadway scenario 200D for a vehicle passing operation. FIG. 2D is not to scale.

In this example, roadway 202 includes centerline markings indicating that passing is permitted in the travel direction of vehicles 102 and 104. Accordingly, the illustrated portion of roadway 202 in this example is a static pass zone.

In scenario 200D, vehicles 102, 103, and 104 are traveling on a roadway 202 that has two lanes 204 and 205, one in each of two opposing directions. Vehicle 102 is travelling at a speed V₁ in a same direction and lane 204 as vehicle 104 at a distance D_{B} behind vehicle 104. Vehicle 104 in this example may be similar to vehicle 102 or may be a large and/or slower moving vehicle such as a truck (shown), bus, piece of farm equipment, RV, towed trailer, etc. travelling at a speed V₂, which for purposes of this example is a speed lower than V₁. Additionally, vehicle 103 is travelling at a speed V₃ in the opposite direction in lane 205 at a distance D_{A} ahead of vehicle 104.

Based upon a planned route of the first vehicle 102, a speed V₁ of vehicle 102, and a speed V₂ of the second vehicle 104, server 118 may predict that vehicle 102 will likely pass vehicle 104 and consider vehicle 102 as a candidate passing vehicle.

In an example implementation of the present disclosure, a server 118 may receive, such as via wireless communications, respective vehicle data for a plurality of vehicles on a roadway, e.g., vehicles 102, 103, and 104 on roadway 202. For example, with respect to FIG. 2D, vehicle data may include dimensions (e.g., length and width) and locations (e.g., geo-coordinates) of vehicles 102, 103, and 104, as well as their respective speeds V₁, V₃, and V₂, and directions of travel on roadway 202. The vehicle data for a vehicle can be provided by the vehicles, or additionally or alternatively could be provided by other nearly vehicles (not shown) or roadside units 120. For example, data about a vehicle that is not in communication with server 118 (i.e., is unconnected), could be provided by sensors of a roadside unit 120 and/or by sensors of a vehicle 102, 103 that is in communication with the server 118.

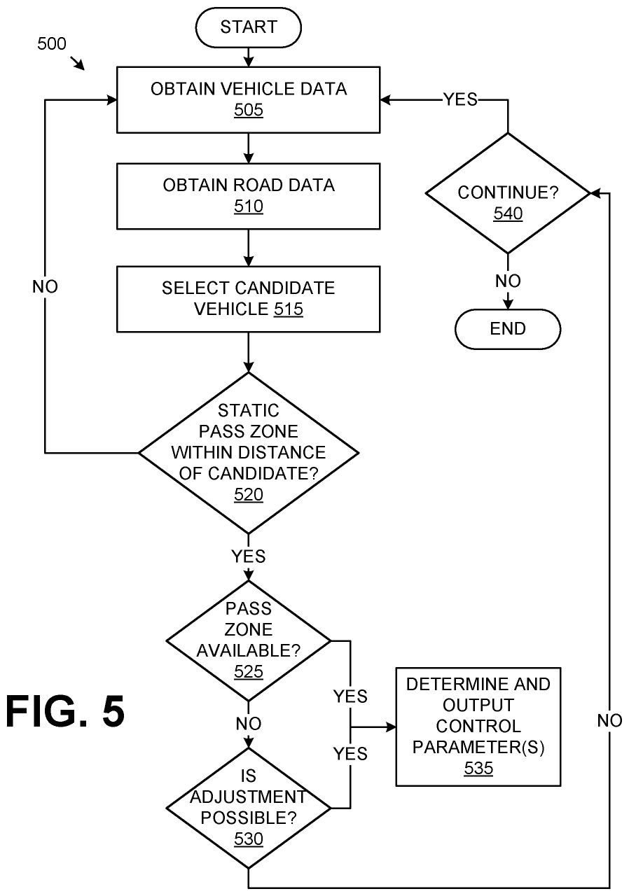

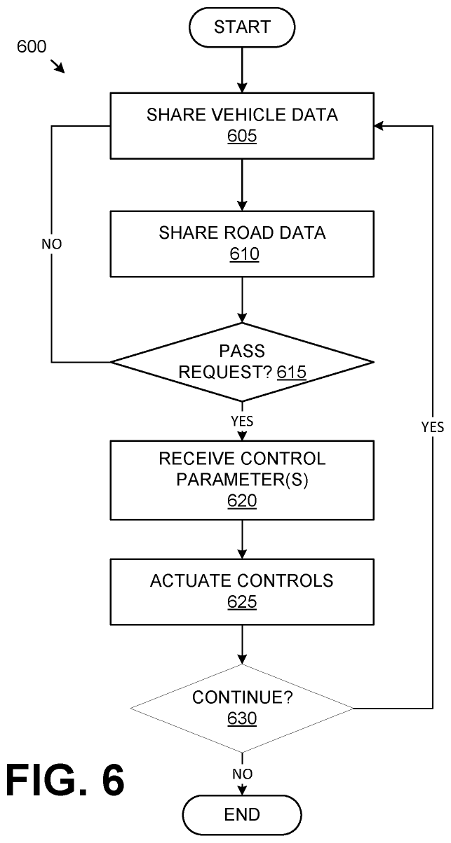

The server 118 may also determine a set of current pass zones and a set of current no-pass zones on the roadway based on the speed and location data from the plurality of vehicles 102, 103, and 104, a set of static no-pass zones, and a set of static pass zones. In an implementation with vehicle 102 as a candidate passing vehicle, a look-ahead distance D_{LA} in front of candidate passing vehicle 102 may be the portion of roadway 202 that server 118 evaluates for determining the relevant sets of current pass zones and current no-pass zones for candidate passing vehicle 102. As discussed further below with respect to FIGS. 5 and 6, vehicle 102 may request a pass and/or the server may select a candidate passing vehicle 102 for a vehicle passing operation. Accordingly, the server 118 needs to evaluate the roadway 202 ahead of the candidate passing vehicle 102 for a distance sufficient to provide a vehicle passing operation for candidate passing vehicle 102, which is referred to as the look-ahead distance D_{LA}.

A location of the candidate passing vehicle 102 may be used to define a start point for the look-ahead distance D_{LA} for a portion of the roadway 202 that server 118 evaluates to determine the sets of current pass zones and current no-pass zones. The look-ahead distance D_{LA} may be selected in any suitable manner, including as a fixed or default distance, where the fixed distance may be specified for a portion of a roadway 202, and moreover where the fixed distance may be adjusted. That is, an adjustable distance could be determined based upon traffic conditions, an adjustable distance based upon weather conditions, and/or an adjustable distance based upon the candidate passing vehicle 102 or its operator. For example, a fixed look-ahead distance D_{LA} could be specified for a portion of the roadway 202 according to data stored in and provided by the server 118 e.g., in a map including a roadway 202 and specifying look-ahead distances D_{LA} for respective portions of the roadway 202. In some of limitations, the fixed look-ahead distance D_{LA} could then be adjusted. To adjust the look-ahead distance D_{LA}, the server could implement an algorithm that takes into account traffic conditions, e.g., a traffic density or number of vehicles per unit distance on the portion of roadway 202 and/or average current measured speed of vehicles on the roadway 202, weather conditions, e.g., ambient light, presence or absence of precipitation, etc., on the roadway 202, and/or other factors. The algorithm could provide weights or adjustment factors for various values of traffic conditions, weather conditions, etc. For example, a look-ahead distance D_{LA} could be reduced when traffic density exceeds a threshold, when ambient light exceeds a threshold, when heavy precipitation is present, etc. As will be understood, factors and weights implemented by the server 118 could be determined by simulations and/or empirical testing.

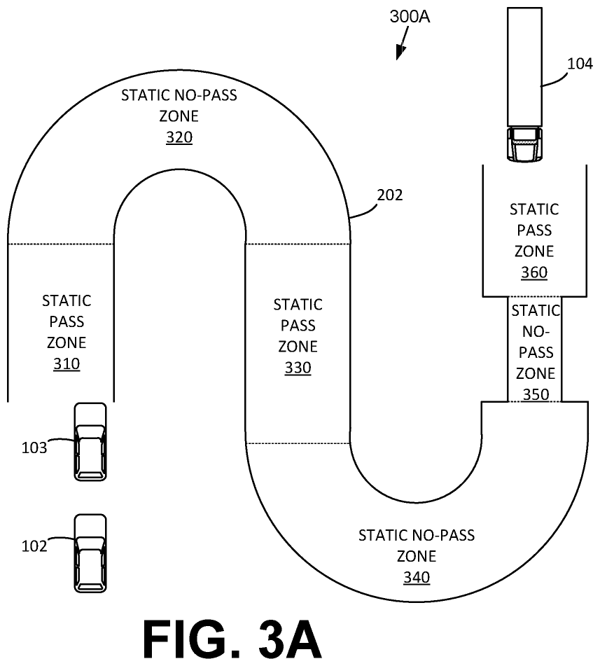

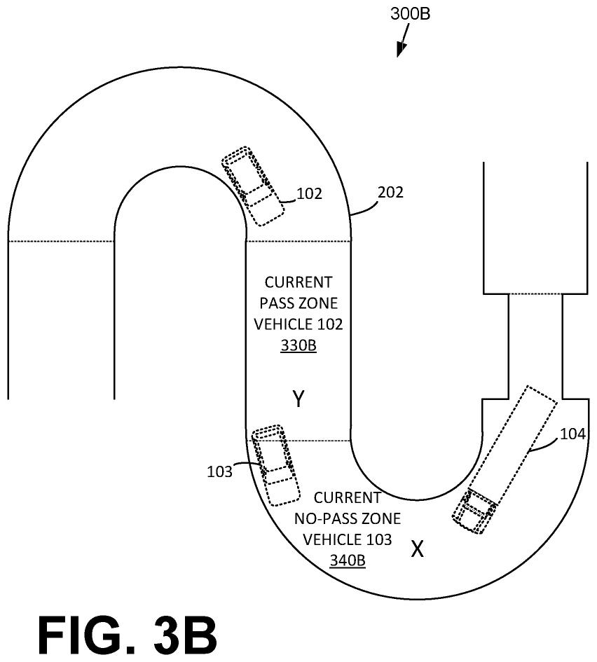

For example, server 118 may store a fixed look-ahead distance D_{LA} of, e.g., 5 miles, for a same-direction or same-lane pass for a portion of a roadway 202, and further the server 118 could adjust the look-ahead distance D_{LA} for traffic conditions such as speed by setting a distance of 4 miles when the speed limit on roadway 202 is 35-40 mph, setting a distance of 5 miles when the speed limit is 45-55 mph, and setting a distance of 6 miles when the speed limit is between 60-70 mph. In this manner, the look-ahead distance D_{LA} can account for an increased D_{PASS} generally associated with higher speeds. Server 118 may use other traffic conditions such as traffic density to adjust the look-ahead distance D_{LA} by a factor, e.g., a multiplier such as between 0.5 and 2.0, so as to lower the look-ahead distance D_{LA} when traffic is sparse and increase the look-ahead distance D_{LA} when traffic is dense. Similarly, server 118 may adjust the look-ahead distance D_{LA} by a factor based on weather or environmental conditions, e.g., a multiplier such as between 0.5 and 2.0, so as to lower the look-ahead distance D_{LA} when conditions are clear and dry and increase the look-ahead distance D_{LA} when weather conditions make vehicle speeds less predictable. The server 118 may set a permitted range of marginal speed changes for a candidate passing vehicle 102 or its associated operator may adjust an amount of marginal speed changes permitted, such as by a user input in the HMI 112. As used herein, changing a vehicle speed “marginally” or a “marginal speed change” of the vehicle means that the speed change is within a permitted or predetermined range (i.e., within a “margin”), which a vehicle user or server 118 may define as a +/− range in percentages or miles per hour. The server 118 may use the amount of marginal speed change permitted to adjust the look-ahead distance D_{LA} by a factor, e.g., as discussed above, so as to lower the look-ahead distance D_{LA} when the marginal speed change is set large, e.g., +/− 5mph, because, the higher the speed, less passing distance may be warranted, and increase the look-ahead distance D_{LA} when the marginal speed change is small, e.g., +/− 2mph, since smaller speed changes lengthen the passing distance D_{PASS} and may limit passing opportunities. Server 118 may include programming to alternatively or additionally consider other factors, including vehicle characteristics such as vehicle length, vehicle weight, trailer towing, etc., that may affect the time the vehicle may be predicted to perform a passing operation. In an implementation where server 118 considers multiple factors, each factor may be applied to the base look-ahead distance D_{LA}, weighted (with respective weights adding up to 1), and added together to determine an adjusted look-ahead distance D_{LA}. Server 118 may use similar principles based upon factors and weights determined by simulations and/or empirical testing in opposite-direction passing to set a different look-ahead distance D_{LA} for an opposite-direction pass (as defined below) of a large vehicle (discussed below with respect to FIGS. 3A and 3B), or may set the D_{LA} the same for both cases.

The server 118 may yet further alternatively or additionally be programmed to take conditions of the roadway 202 within the look-ahead distance D_{LA} into consideration when determining sets of current pass-zones and current no-pass zones. For example, server 118 may consider one or more roadway conditions including but not limited to width, curvature, grade, surface condition, and weather conditions (including glare, darkness, rain, snow, fog, dust, smoke, wind, etc.) to determine if passing may take longer or to adjust the size of any buffer distance added to the passing distance D_{PASS} used to determine sets of current pass-zones and current no-pass zones since each of these conditions may also affect the predictability of vehicle speeds.

In the example illustrated in FIGS. 2A-2D, roadway 202 within look-ahead distance D_{LA} has passing zone center markings and is straight, flat, and exceeds a threshold width to permit passing for the vehicles 102, 103, and 104. Accordingly, the set of static no-pass zones in this example is empty, and the set of static pass zones includes the full length of look-ahead distance D_{LA}.

However, based upon the respective speeds V₁, V₂, and V₃ of candidate passing vehicle 102, vehicle 104, and opposite vehicle 103 and the relative distances D_{B} and D_{A} of candidate passing vehicle 102 and opposite vehicle 103 to vehicle 104 being passed, server 118 may determine a predicted overlap within a region of roadway 202 where the vehicles 102, 103, and 104 are predicted to be within an applicable distance threshold D_{STANDOFF1} Or D_{STANDOFF2} of one another during a passing operation as explained above with respect to FIGS. 2B and 2C, and may designate this predicted overlap region as a current no-pass zone. In an implementation, server 118 may predict vehicle locations for determination of the overlap region by solving basic physics equations of motion (e.g., Δx=v*Δt) or the like known for use in predicting position based on trajectory data.

Thus, based upon determination of the no-pass zone in this example, the set of current pass zones includes the roadway before and after the predicted overlap region, and the set of current no-pass zones includes the predicted overlap region. The extent of the predicted overlap region is determined by the passing distance D_{PASS}, which may be based on rules designed to maintain predetermined standoff distances of vehicles in the same lane depending on speed and direction of travel (e.g., standoff distances D_{STANDOFF1} and D_{STANDOFF2} from FIGS. 2B and 2C) and may include additional buffer distances at either end to account for various uncertainties in vehicle speeds such as weather and driver variance. The standoff distances (i.e., the distances vehicles are permitted to approach one another in the same lane) may be determined with empirical testing or simulation, for example, and may be retrieved, e.g., from a lookup table based on a velocity of the passing vehicle. Buffer distances may be determined as a specified percentage of the calculated passing distance D_{PASS}, such as 10% or 20%, and may depend on a predicted level of uncertainty (e.g., of vehicle speeds) and/or weather and road conditions (darkness, rain, snow, glare, construction, etc.).

A current no-pass zone based on an overlap predicted by server 118 typically depends upon current speeds of the vehicles 102, 103, and 104 on roadway 202. If one or more vehicles 102, 103, 104 adjust their speeds relative to one another, it may be possible to obviate the predicted overlap during a vehicle passing operation and create a current passing zone. Similarly, server 118 may determine control parameters for adjusting the speed of one or more vehicles 102, 103, 104 to preclude a current no-pass zone that is based on a static no-pass zone in order to permit a vehicle passing operation.

In the current example, in order to have candidate passing vehicle 102 preclude passing vehicle 104 in a current no-pass zone, server 118 may select a current pass zone from a set of current pass zones and transmit a control parameter for the candidate passing vehicle 102 to have a passing operation occur in the selected current pass zone. As used herein, a control parameter means one or more data values, i.e., criteria, instruction, or threshold, that may be used for actuation of a propulsion, braking, or steering subsystem of a vehicle to facilitate a vehicle passing operation. For example, a control parameter may instruct candidate passing vehicle 102 to increase speed within the marginal speed change limits (i.e., marginally) to pass vehicle 104 before opposite vehicle 103 becomes within the distance D_{STANDOFF2}. To facilitate the passing operation, a control parameter may also include a steering instruction for candidate passing vehicle 102, such as to steer into opposing lane 205 and steer back into travel lane 204. Similarly, server 118 may instruct candidate passing vehicle 102 to slow down marginally to permit opposite vehicle 103 to pass vehicle 104 before the candidate passing vehicle 102 begins passing vehicle 104.

Alternatively, server 118 may transmit a control parameter for the candidate passing vehicle 102 to maintain, increase, or decrease speed and transmit one or more further control parameters to one or more of the other vehicles 103 and 104 instructing them to maintain, increase, or decrease speed such that the passing operation and traffic flow may be more coordinated (and the speed adjustments for each vehicle are smaller).

The various instructions of the control parameters may be displayed to an operator of the associated vehicle (102, 103, and/or 104) on an HMI when a vehicle is controlled by the operator and/or may be used by a vehicle computer 105 to actuate a vehicle subsystem when advanced driver assist systems or the like, such as adaptive cruise control, are active in the vehicle, i.e., operating one or more of propulsion, steering, or braking.

A greater lookahead distance D_{LA} can permit server 118 to transmit control parameters to the one or more vehicles earlier so that small changes can have larger effects over time, but a greater lookahead distance D_{LA} also may require collection of more data and additional computational load for determination of possible overlaps at server 118. Accordingly, appropriate selection of a lookahead distance D_{LA} for a candidate passing vehicle may balance these factors.

FIGS. 3A and 3B illustrate an example two-lane roadway scenario 300A at an initial point and 300B based upon prediction for a vehicle passing operation. FIGS. 3A and 300B are not to scale and are used to illustrate concepts of the present disclosure. The velocity and relative distance indications for each vehicle 102, 103, and 104 as used in FIG. 2D are omitted for clarity, with vehicle 104 within look-ahead distance D_{LA} of vehicles 102 and/or 103.

Scenarios 300A and 300B relate to a vehicle passing operation wherein it is desirable for a vehicle 102 or 103 travelling in a first direction to preclude passing a large vehicle travelling in an opposite direction at certain points, such as blind curves, tight curves, narrow sections, and single lane sections. Such a situation is referred to as an opposite-direction pass or an opposite-lane pass.

In scenario 300A, vehicles 102, 103, and 104 are traveling on a roadway 202 that has two lanes, one in each of two opposing directions, or is otherwise intended for two-way traffic. Vehicle 102 is travelling at a speed V₁ in a same direction as vehicle 103 at a distance D_{B} from vehicle 104. Vehicle 104 in this example is a large vehicle such as a truck, bus, piece of farm equipment, RV, towed trailer, etc., travelling at a speed V₂ in the opposite direction on roadway 202. Additionally, vehicle 103 is travelling at a speed V₃ in the same direction as vehicle 102 at a distance D_{A} from the large vehicle 104 that is closer than distance D_{B} from the large vehicle 104.

Based upon the planned routes of vehicles 102, 103, and 104 on roadway 202, each of vehicles 102 and 103 will need to pass large vehicle 104 in the opposing direction. However, based upon its dimensions, large vehicle 104 may be too wide for vehicle 102 and 103 to comfortably pass in the tight blind curves and/or narrow sections of roadway 202.

In an example implementation of the present disclosure, a server 118 may receive, such as via wireless communications, respective vehicle data for a plurality of vehicles on a roadway, e.g., vehicles 102, 103, and 104 on roadway 202. For example, with respect to FIG. 3A, vehicle data may include dimensions (e.g., length and width) and locations (e.g., geo-coordinates) of vehicles 102, 103, and 104, as well as their respective speeds V₁, V₃, and V₂, and directions of travel on roadway 202. A vehicle can provide vehicle data about itself, or additionally or alternatively, other vehicles (not shown) or roadside units 120 may provide data for a vehicle. For example, sensors of a roadside unit 120 and/or sensors of a vehicle 102 that is in communication with the server 118 may provide data about a vehicle 103 that is not in communication with server 118 (i.e., is unconnected).

The server 118 may also determine a set of current pass zones and a set of current no-pass zones on a look-ahead distance D_{LA} of the roadway based on the speed and location data from the plurality of vehicles 102, 103, and 104, a set of static no-pass zones, and a set of static pass zones. In the present example, roadway 202 may or may not have centerline markings, and includes blind turns and a narrow portion. Accordingly, as illustrated in FIG. 3A, a set of static no-pass zones in this example may include static no-pass zones 320 and 340 associated with the blind turns and static no-pass zone 350 associated with a narrow portion that is not wide enough for two vehicles at the same time (e.g., one lane bridge). Alternately, the narrow portion may be wide enough to accommodate two opposing cars, but not wide enough to accommodate opposing vehicles when one is wide (truck, bus, etc.) such as large vehicle 104. While such blind and narrow no-pass zones may be designated as static no-pass zones for purposes of passing in the same direction (e.g., and include solid centerline markings), server 118 may also designate these types of no-pass zones as static no-pass zones for purposes of opposite passing with large vehicles.

FIG. 3B illustrates a predicted scenario 300B based upon the initial conditions of scenario 300A. Based upon the respective speeds V₁, V₂, and V₃ of vehicle 102, large vehicle 104, and vehicle 103 and the relative distances D_{B} and D_{A} of vehicle 102 and vehicle 103 to large vehicle 104 being passed, server 118 may determine a predicted overlap region of roadway wherein the vehicles 102 and 103 are predicted to pass large vehicle 104 in the opposing direction. The extent of the predicted overlap regions for vehicles 102 and 103 may include a predicted overlap location and additional buffer zones at either end to account for various uncertainties in vehicle speeds such as weather and driver variance.

In scenario 300B, server 118 may determine that a predicted overlap for vehicle 103 falls at location X within a static no-pass zone 340 of scenario 300A. In this case, the server may determine the static no-pass zone to be a current no-pass zone 340B for vehicle 103 based upon the predicted overlap. To obviate such an overlap, server 118 may transmit control parameters to vehicle 103 to have the predicted overlap location X fall within a current pass zone. For example, a control parameter may instruct a candidate passing vehicle 103 to slow to be within a permitted marginal speed change to pass large vehicle 104 in pass zone 330 (FIG. 3A) to identify a current pass zone 330B (FIG. 3B). Similarly, the server 118 may determine that a predicted overlap region for vehicle 102 falls at location Y within a static pass zone 330 of scenario 300A. In this case, the server may determine the static pass zone 330 (FIG. 3A) to be a current pass zone 330B (FIG. 3B) for vehicle 102. The server 118 may transmit control parameters to vehicle 102 to maintain speed or otherwise have a predicted respective overlap region fall within the current pass zone 330B. For example, a control parameter may instruct vehicle 102 to maintain its speed or perhaps slow down marginally to maintain a distance from vehicle 103 yet still pass large vehicle 104 in pass zone 330 to make it a current pass zone 330B for vehicle 102.

Alternatively or additionally, server 118 may transmit a control parameter for a candidate passing vehicle 102 or 103 to maintain, increase, or decrease speed and transmit one or more further control parameters to the large vehicle 104 instructing it to maintain, increase, or decrease speed such that the passing operation and traffic flow may be more coordinated (and the speed adjustments smaller) while still having the opposite-direction vehicle passing operations occur in a current pass zone selected from the static pass zones of scenario 300A.

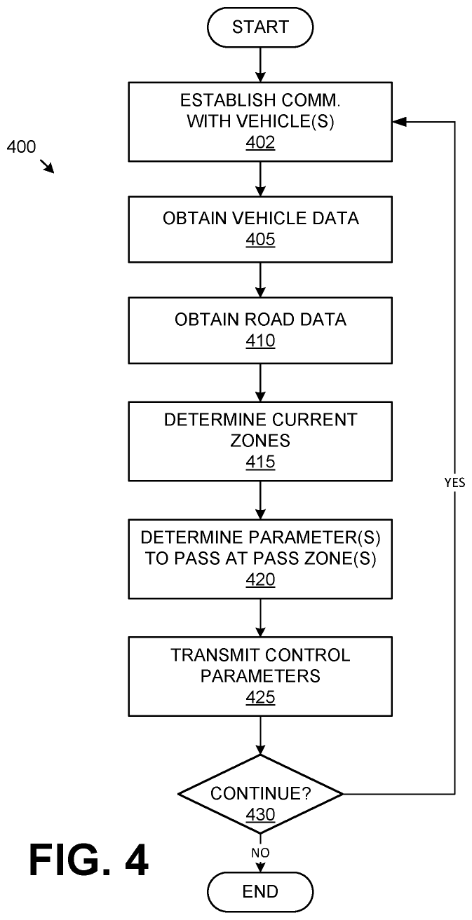

FIG. 4 is a process flow diagram of an example process 400 for a vehicle passing operation. Process 400 may apply to a same-direction passing operation as illustrated in FIGS. 2B-2D or an opposite-direction passing operation as illustrated in FIGS. 3A and 3B.

The process 400 may begin at a block 402, when multiple vehicles are operating on a portion of a two-lane roadway, and a central computer such as server 118 establishes communication with at least one of the vehicles in the portion of the roadway. For example, vehicle 102 may be in communication with server 118, such as via wireless communications, and may share route data from a navigation subsystem indicating a planned route on roadway 202 or may share location data indicating current travel on roadway 202. The portion of the roadway could be predetermined and stored along with map data, and/or could be a portion of the roadway defined as being within a specified distance or radius of a landmark or object such as a roadside unit 120.

In a next block 405, server 118 obtains vehicle data for a plurality of vehicles (e.g., vehicles 102, 103, and 104) operating or planning to operate on a portion of two-lane roadway (e.g., roadway 202). Server 118 may receive, such as via wireless communications, respective vehicle data for a plurality of vehicles on a roadway, e.g., vehicles 102, 103, and 104 on roadway 202. For example, vehicle data may include dimensions (e.g., length and width) and locations (e.g., geo-coordinates) of vehicles 102, 103, and 104, as well as their respective speeds V₁, V₃, and V₂, and directions of travel on roadway 202. As discussed with respect to FIGS. 2D and 3A, 3B, a vehicle can provide vehicle data about itself, or additionally or alternatively, other vehicles (not shown) or roadside units 120 may provide data for a vehicle. For example, sensors of a roadside unit 120 and/or by sensors of a vehicle 102 that is in communication with the server 118 may provide data about a vehicle 103 that is not in communication with server 118 (i.e., is unconnected).

In a block 410, server 118 obtains road data for roadway 202. Road data may include, but is not limited to, roadway boundaries, roadway or lane widths, roadway centerline markings, designated static pass and no-pass zones, roadway curves, roadway grades, roadway surface conditions, roadway weather conditions (including surface conditions such as water, snow, or ice and visibility conditions such as darkness, glare, rain, snow, fog, smoke, or sand), roadway construction boundaries, roadside obstructions to visibility (e.g., blind curves), and posted roadway speed limits. Server 118 may obtain road data from one or more sources, including digital maps, sensors of a roadside unit 120 that is in communication with the server 118, sensors of a vehicle 102 that is in communication with the server 118, and weather data for an area including a portion of the roadway 202, for example.

In a next block 415, server 118 determines current pass and no-pass zones for a candidate passing vehicle such as vehicle 102 in communication with server 118. Server 118 may default to selecting a candidate passing vehicle 102 when passing is predicted (e.g., vehicle 102 approaching a slower moving vehicle 104 on roadway 202), or may receive a pass request from vehicle 102. As used herein, a pass request from vehicle 102 is a specific request to server 118 to request a passing operation of a specified second vehicle or a request from vehicle 102 to server 118 that it desires to perform passing operations when possible with respect to slow-moving vehicles in the portion of the roadway. As disclosed with respect to FIGS. 2D and 3, server 118 may evaluate a look-ahead distance D_{LA} of vehicle 102 along roadway 202 and determine current pass and no-pass zones for vehicle 102 for same-lane passing (e.g., FIG. 2D) and/or opposite-lane passing (FIG. 3) based upon the speed, location, and dimension data for the plurality of vehicles (e.g., 102, 103, 104), and a set of static no-pass zones and a set of static pass zones from the road data. Server 118 may also consider vehicle speeds, roadway speed limits, weather conditions, and/or traffic conditions when determining a look-ahead distance D_{LA} for vehicle 102 along roadway 202 and/or determining a standoff distance or buffer used to estimate a passing distance D_{PASS}.

In a next block 420, server 118 determines one or more control parameters for a passing operation to occur at or in one or more pass zones. If server 118 predicts that candidate passing vehicle 102 at its current speed can perform a passing operation with respect to a first vehicle in a current pass zone (i.e., D_{PASS} falls within a current pass zone), it can evaluate a next possible passing operation for passing a second vehicle, if needed. If server 118 predicts candidate passing vehicle 102 at its current speed cannot perform a passing operation with respect to another vehicle because, at current vehicle speeds the passing operation would occur in a current no-pass zone (i.e., D_{PASS} overlaps with a current no-pass zone), server 118 can evaluate possible vehicle speed changes (i.e., possible control parameters), typically but not necessarily within a marginal range as described above, that will permit candidate passing vehicle 102 to perform a passing operation in a pass zone. When evaluating such scenarios, server 118 may only evaluate possible speed changes of vehicles in communication with the server 118. In an implementation, server 118 can evaluate possible speed changes of candidate passing vehicle 102 that will permit a passing operation to occur in a pass zone, and can also evaluate possible speed changes of other vehicles on the roadway 202.

In a block 425, server 118 may transmit one or more control parameters to one or more vehicles in communication with server 118 to effect a passing operation for candidate passing vehicle 102. For example, if server 118 predicts that candidate passing vehicle 102 at its current speed can perform a passing operation with respect to another vehicle in a current pass zone, a control parameter may instruct vehicle 102 to maintain its current speed. Similarly, if server 118 predicts candidate passing vehicle 102 at its current speed cannot perform a passing operation with respect to the other vehicle because, at current vehicle speeds the passing operation would occur in a current no-pass zone, a control parameter may instruct vehicle 102 and/or other vehicles in communication with server 118 to speed up marginally or slow down marginally to effect a passing operation in a current pass zone (i.e., have D_{PASS} fall within a current pass zone). Accordingly, server 118 determines at least one control parameter based on the set of current pass-zones and the set of current no-pass zones for the candidate passing vehicle 102. In an implementation, server 118 may transmit one or more further respective control parameters to one or more vehicles on the roadway, in addition to transmitting the control parameter to the candidate passing vehicle 102.

In a next block 430, server 118 determines whether to continue the process 400. If process 400 was initiated by a pass request that has been completed or the vehicle 102 stops communicating with server 118, the server 118 can end the process 400 (i.e., determine “NO” at block 430). If server 118 determines that the passing operation based upon a pass request has not yet occurred, server 118 can continue executing (i.e., determine “YES” at block 430) until the candidate passing vehicle 102 performs the passing operation in order to account for updated conditions (i.e., updated vehicle data and road data) and/or, if not in response to a pass request related to a specific vehicle, can continue executing (i.e., determine “YES” at block 430) to possibly perform additional passing operations for candidate passing vehicle 102, e.g., as long as data is being received from the vehicle 102.

FIG. 5 illustrates another example process 500 for a vehicle passing operation. Process 500 may apply to a same-direction passing operation as illustrated in FIGS. 2B-2D or an opposite-direction passing operation as illustrated in FIG. 3.

The process 500 may begin when multiple vehicles are operating on a portion of a two-lane roadway, with at least one vehicle in communication with a central computer such as server 118. For example, vehicle 102 may be in communication with server 118, such as via wireless communications, and may share route data from a navigation subsystem indicating a planned route on roadway 202 or may share location data indicating current travel on roadway 202.

In a first block 505, a central computer such as server 118 obtains vehicle data for a plurality of vehicles (e.g., vehicles 102, 103, and 104) operating or planning to operate on a portion of two-lane roadway (e.g., roadway 202), as discussed above with respect to block 405 in FIG. 4.

In a block 510, server 118 obtains road data for roadway 202, as discussed above with respect to block 410 in FIG. 4.

In a next block 515, server 118 selects a candidate vehicle for a passing operation, such as candidate passing vehicle 102. Server 118 may select candidate passing vehicle 102 based upon receiving a pass request from candidate passing vehicle 102, or may select candidate passing vehicle 102 based upon server 118 making a prediction that candidate passing vehicle 102, based on its current route and speed, will be subject to pass another vehicle 104, either in a same-direction pass (e.g., as in FIG. 2D) or an opposite-direction pass of a large vehicle (e.g., as in FIG. 3A).

In a block 520, server 118 determines whether there is a static pass zone within a specified look-ahead distance D_{LA} of vehicle 102 along roadway 202. The server 118 retrieves a set of static pass zones for vehicle 102 for same-lane passing (e.g., FIG. 2D) and/or opposite-lane passing (FIGS. 3A and 3B) for the look-ahead distance D_{LA} portion of roadway 202 from the road data to make the determination. If server 118 determines “NO” at block 520 (i.e., the set of static pass zones in the look-ahead distance D_{LA} of vehicle 102 is empty or null), a passing operation cannot be made at this time and the process 500 returns to another iteration of obtaining vehicle data at block 505. If server 118 determines “YES” at block 520, the process 500 moves to a block 525.

In block 525, server 118 determines whether a pass zone for candidate passing vehicle 102 is available by determining current pass zones (and current no-pass zones) for candidate passing vehicle 102 based upon the speed, location, and dimension data for the plurality of vehicles (e.g., 102, 103, 104), and the set of static pass zones from the road data. Server 118 may also consider vehicle speeds, roadway speed limits, weather conditions, and/or traffic conditions when determining a standoff distance or buffer used to estimate a passing distance D_{PASS} used for determining current pass zones, such as described with respect to FIGS. 2B and 2C. If server 118 determines that a pass zone for candidate passing vehicle 102 is available (i.e., “YES” at block 525), process 500 proceeds to a block 535.

If server 118 determines that a pass zone for candidate passing vehicle 102 is not available (i.e., “NO” at block 525), process 500 proceeds to a block 530 where server 118 determines whether an adjustment to one or more vehicles in communication with server 118 would make a pass zone available. If server 118 determines that an adjustment is possible (i.e., “YES” at block 530), process 500 proceeds to block 535. If server 118 determines that an adjustment is not possible (i.e., “NO” at block 530), process 500 proceeds to a block 540.

In block 535, server 118 determines and outputs one or more control parameters to one or more vehicles in communication with server 118 to effectuate a passing operation for candidate passing vehicle 102.

When a passing operation for candidate passing vehicle 102 is not currently possible, i.e., server 118 has made a “NO” determination at block 530, server 118 determines whether the process 500 should continue at block 540. If candidate passing vehicle 102 is continuing on its route and/or there are additional vehicles in communication with server 118 that may be selected for possible passing operations, server 118 may continue process 500 (i.e., determine “YES” at block 540) and return to block 505 to continue obtaining vehicle data. If candidate passing vehicle completes its route and there are no additional vehicles in communication with server 118 that may be selected for possible passing operations, server 118 may end process 500 (i.e., determine “NO” at block 540).

FIG. 6 illustrates an example flow diagram of a process 600 performed at a vehicle 102 for a vehicle passing operation. Process 600 may apply to a same-direction passing operation as illustrated in FIGS. 2B-2D or an opposite-direction passing operation as illustrated in FIGS. 3A and 3B.

Process 600 may start when a vehicle computer 105 initiates wireless communication with server 118 via communication module 114.

In a first block 605, vehicle computer 105 shares vehicle data with server 118. The vehicle data may include dimensions (e.g., length and width), location (e.g., geo-coordinates), speed V₁, and planned route of vehicle 102, and may further include dimensions (e.g., length and width) and location (e.g., geo-coordinates) of other nearby vehicles 103 and 104, as well as their respective speed V₃ and V₂, and directions of travel on roadway 202 shared by V2V or V2X communications with vehicle 102 and/or collected by the sensors 108 of vehicle 102.

In a next block 610, vehicle computer 105 shares road data with server 118. Road data may be collected by computer 105 based on input from sensors 108 and may include the data discussed above with respect to block 410 in FIG. 4.

In a block 615, vehicle computer 105 determines whether a pass request has been made. A user input, such as a general setting selection to request a passing operation in the event of approaching a slower-moving vehicle or a specific user input to request a current passing operation of a particular vehicle may indicate to vehicle computer 105 that a pass request has been made by vehicle 102. In a further implementation, vehicle 102 may participate in passing operations for other vehicles in communication with server 118 and may receive a notification of a pass request made by another vehicle. If vehicle computer 105 determines that a pass request has not been made (i.e., “NO” at block 615), process 600 returns to block 605. If vehicle computer 105 determines that a pass request has been made (i.e., “YES” at block 615), process 600 proceeds to block 620.

In a block 620, vehicle computer 105 receives one or more control parameters from server 118 to effect a passing operation, either for vehicle 102 or another vehicle in communication with server 118, for example as disclosed above with respect to FIGS. 2D and FIGS. 3A and 3B.

In a next block 625, vehicle computer 105 actuates controls of vehicle 102 based upon the one or more control parameters. In one implementation, vehicle computer 105 may actuate a display of HMI 112 to indicate a requested speed change. In another implementation, vehicle computer 105 may actuate a vehicle subsystem when advanced driver assist systems or the like, such as adaptive cruise control, are active in the vehicle 102, i.e., operating one or more of propulsion, steering, or braking, to perform a requested speed change and/or lane change.

In a next block 630, vehicle computer 105 determines whether the process 600 should continue. If vehicle 102 is continuing on its route, vehicle computer 105 may continue process 600 (i.e., determine “YES” at block 630) and return to block 605 to continue sharing vehicle data. If vehicle 102 has completed its route, vehicle computer 105 may end process 600 (i.e., determine “NO” at block 630).

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

In the drawings, the same or like reference numbers indicate the same or like elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a computer including a processor and a memory, the memory storing instructions executable by the processor such that the computer is programmed to:
receive, via wireless communications, respective vehicle data for each of a plurality of vehicles on a roadway, the vehicle data including at least speed and location data;
determine a set of current pass zones and a set of current no-pass zones on the roadway based on the speed and location data from the plurality of vehicles, a set of static no-pass zones, and a set of static pass zones; and
transmit a control parameter for a candidate passing vehicle in the plurality of vehicles, wherein the control parameter is determined based on the set of current pass-zones and the set of current no-pass zones.

2. The system of claim 1, further comprising instructions to:
transmit one or more further respective control parameters to one or more vehicles in the plurality of vehicles, in addition to transmitting the control parameter to the candidate passing vehicle.

3. The system of claim 1, wherein the control parameter includes a steering instruction for the candidate passing vehicle.

4. The system of claim 1, further comprising instructions to:
determine the control parameter based on a location of a current pass zone selected from the set of current pass zones.

5. The system of claim 1, wherein the instructions to determine the sets of current pass-zones and current no-pass zones take a location of the candidate passing vehicle into consideration.

6. The system of claim 5, wherein the location of the candidate passing vehicle is used to define a start point for a look-ahead distance for a portion of the roadway evaluated to determine the sets of current pass zones and current no-pass zones, wherein the look-ahead distance is selected from a fixed distance, an adjustable distance based upon traffic conditions, an adjustable distance based upon weather conditions, or an adjustable distance based upon the candidate passing vehicle.

7. The system of claim 1, wherein the instructions to determine the sets of current pass-zones and current no-pass zones takes a roadway condition into consideration.

8. The system of claim 7, wherein the roadway condition includes one of a width, a curve, a grade, a surface condition, and a weather condition.

9. The system of claim 1, wherein the vehicle data includes vehicle dimension data.

10. The system of claim 1, wherein at least one of the sets of current pass-zones, current no-pass zones, static no-pass zones, and static pass zones is empty.

11. The system of claim 1, further comprising instructions to:
receive, from the candidate passing vehicle, a pass zone request.

12. The system of claim 1, further comprising instructions to:
receive the vehicle data for a first one of the plurality of vehicles from a roadside infrastructure element or a second one of the plurality of vehicles.

13. The system of claim 1, further comprising a vehicle computer in the candidate passing vehicle including a processor and a memory, the memory storing instructions executable by the processor such that the vehicle computer is programmed to:
control at least one of speed or steering according to the transmitted control parameter.

14. A method, comprising:
receiving, via wireless communications, respective vehicle data for each of a plurality of vehicles on a roadway, the vehicle data including at least speed, location, and dimension data;
determining a set of current pass zones and a set of current no-pass zones on the roadway based on the speed and location data from the plurality of vehicles, a set of static no-pass zones, and a set of static pass zones; and
transmitting a control parameter for a candidate passing vehicle in the plurality of vehicles, wherein the control parameter is determined based on a location of a current pass zone selected from the set of current pass zones.

15. The method of claim 14, further comprising transmitting one or more further respective control parameters to one or more participating vehicles in the plurality of vehicles, in addition to transmitting the control parameter to the candidate passing vehicle.

16. The method of claim 14, wherein determining the sets of current pass-zones and current no-pass zones is further based on a location of the candidate passing vehicle and a roadway condition that includes one of a curve, a grade, a lane width, a surface condition, or a weather condition.

17. The method of claim 16, wherein the location of the candidate passing vehicle is used to define a start point for a look-ahead distance for a portion of the roadway evaluated to determine the sets of current pass zones and current no-pass zones, wherein the look-ahead distance is selected from a fixed distance, an adjustable distance based upon traffic conditions, an adjustable distance based upon weather conditions, or an adjustable distance based upon the candidate passing vehicle.

18. The method of claim 14, further comprising, in the candidate passing vehicle, controlling at least one of speed or steering according to the control parameter.

19. The method of claim 14, further comprising receiving the vehicle data for a first one of the plurality of vehicles from a roadside infrastructure element or a second one of the plurality of vehicles.

20. The method of claim 14, further comprising receiving, from the candidate passing vehicle, a pass zone request.
